(19) United States
(12) Patent Application Publication
(10) Pub. No.: US 2005/0064844 A1
(43) Pub. Date: Mar. 24, 2005

(54) Mobile user location tracking system

(76) Inventors: Derek McAvoy, Toronto (CA); Oleg Lebedko, Woodbridge (CA); Igor Shushakov, Etobicoke (CA)

Correspondence Address: FETHERSTONHAUGH - SMART & BIGGAR, 1000 DE LA GAUCHETIERE WEST, SUITE 3300, MONTREAL, QC, H3B 4W5, CA

(21) Appl. No.: 10/943,028

(22) Filed: Sep. 17, 2004

(30) Foreign Application Priority Data
Sep. 19, 2003 (WO) PCT/CA03/01428

(51) Int. Cl. H04M 11/00

(52) U.S. Cl. 455/405; 455/456.1

(57) ABSTRACT

A mobile user tracking system and method for use in a wireless communication network tracks call history information of mobile users. The system has a data parsing unit for receiving data associated with calls made by mobile users and for filtering the data into associated call history information data. The system has a network configuration database for storing network configuration information data. The system has a client system adapted to access selected mobile user information data and associated call history information data and to access network configuration information data. The client system has a mobile user positioning processor responsive to the selected mobile user information data, associated call history data and the access network configuration information data to develop mobile user position information data that represents geographical position of the mobile user in the network. The system displays call history information on a visual geographical map.

### FIELD OF THE INVENTION

The present invention relates to a method and system for historical tracking of one or more mobile users while on a call in a wireless telecommunication network.

### BACKGROUND OF THE INVENTION

It should be understood that the term “mobile user” used throughout the specification includes mobile telecommunication units that communicate with a base station in a wireless telecommunication network by means of electromagnetic waves such as mobile wireless telephones and cellular telephones that are designed to exchange voice information with the base station. The term mobile user also includes data communication devices and hybrid devices such as personal communications systems that have both telephone and data communication features.

It is known to use a wireless network based location system to locate the position of an active phone or a transceiver unit in a network. Once such system is disclosed in U.S. Pat. No. 5,844,522 issued Dec. 1, 1998 to Sheffer et al. This system includes plurality of agile vector sensor units installed at each antenna site in the network and a remote control monitoring station to which the wireless network users can call for assistance in the event of an emergency. The system is designed to locate a portable phone transceiver unit using the reverse voice channel signal transmitted by the transceiver unit. This is a real time position locator for the mobile telephone in the system and is responsive to an emergency condition.

However, it will be appreciated that when a network administrator wishes to track mobile user traffic on the network to determine the location of dropped calls, to determine the path of the movement of mobile users in the network, and/or to determine the network utilization by the mobile users, this tracking operation involves analyzing several million data records relating to active calls in a network over periods or days or weeks. Further, this data usually includes fields of information not relevant to caller position in the network. This additional irrelevant information makes any analysis more cumbersome and time consuming.

Accordingly, there is a need to develop a tracking and analyzing system for tracking active and dropped calls of mobile users in a network during predetermined time intervals and for selected regions of the network.

### SUMMARY OF THE INVENTION

The present invention relates to a method and system for historical tracking of one or more mobile users while on a call in a wireless telecommunication network.

The present invention relates to a wireless communication network having a mobile user tracking system for collecting data associated with mobile users making calls in the network. The network tracking system includes a data parsing unit for receiving data associated with calls made by mobile users in the network and for filtering the data into parsed data that may be limited to mobile user information data and associated call history information data. The network further includes a call history database for storing the parsed data. In one embodiment the mobile user information data comprises customer information data including customer telephone numbers. In one embodiment the associated call history information data includes dropped call information, base station cell site identification and mobile signal location information relative to the base station cell site.

The tracking system further accesses the network configuration database for storing network configuration information data such as, for example, geographical locations for the location of a base station cell site to utilize this information in tracking the mobile users.

The tracking system also comprises a client system adapted to access selected mobile user information data and associated call history information data from the call history database and to access network configuration information data from the network configuration database. The client system has a mobile user positioning processor responsive to the selected mobile user information data, associated call history data and the access network configuration information data to develop mobile user position information data that represents geographical position of the mobile user in the network. In one embodiment the selected mobile user information data and associated call history is selected by one or more of network region, telephone number, and time of day.

The mobile user positioning system of the client system comprises an administrative unit and a processing unit. The mobile user positioning system forwards the selected mobile user information data and associated call history information data to the processing unit for development of initial mobile user position information data. The processing unit also forwards the initial mobile user position information back the administrative unit that processes the initial mobile user position information with the network configuration information data to develop the mobile user position information data. Alternatively, the administrative unit receives the selected mobile user information data, associated call history information data and network configuration information data and forwards the selected mobile user information data, associated call history information data and network configuration information data to the processing unit for development of the mobile user position information data.

The client system may include a local storage database for storing the mobile user position information data.

The client system may further include a mapping display unit that displays the developed mobile user position information data received from the local storage database on a geographical map of at least a portion of the network. The display map in one embodiment is adapted to display one or more tracked mobile user calls in progress as the mobile users move through the network, a density of mobile user calls in a predetermined region of the network, and a display of one or more dropped calls in a predetermined region of the network.

In accordance with one aspect of the present invention there is provided a wireless communication network having a mobile user tracking system for collecting data associated with mobile users making calls in the network. The tracking system comprises a data parsing unit for receiving data associated with calls made by mobile users in the network and for filtering the data into parsed data that includes mobile user information data and associated call history information data. The system further comprises a call history database for storing the parsed data.

In accordance with another aspect of the present invention there is provided a tracking system for use in a wireless communication network for analyzing data associated with a mobile user on calls in the network. The mobile user tracking system comprises a client system adapted to access mobile user information data and associated call history information data from the network and adapted to access network configuration information data from the network. The client system has a mobile user positioning processor responsive to the selected mobile user information data, associated call history data and the access network configuration information data to develop mobile user position information data that represents geographical position of the mobile user in the network.

In accordance with another aspect of the present invention there is provided a method of tracking mobile users in a wireless communications network comprising the steps of:
collecting data associated with mobile users making calls in the network,
filtering the collected data into parsed data that includes mobile user information data and associated call history information data; and,
storing the parsed data in the network.

In accordance with another aspect of the present invention there is provided a method of remotely analyzing data associated with mobile users on calls in the wireless communications network, the method comprising the steps of:
accessing selected mobile user information data and associated call history information data from the network;
accessing network configuration information data from the network; and,
processing the selected mobile user information data, associated call history data and the access network configuration information data to develop mobile user position information data that represents geographical position of the mobile user in the network.

In accordance with another aspect of the present invention there is provided an apparatus of tracking mobile users in a wireless communication network comprising:
means for collecting data associated with mobile users making calls in the network,
means for filtering the collected data into parsed data that includes mobile user information data and associated call history information data; and,
means for storing the parsed data in the network.

In accordance with another aspect of the present invention there is provided an apparatus of remotely analyzing data associated with mobile users on calls in the wireless communication network, the apparatus comprising:
means for accessing selected mobile user information data and associated call history information data from the network;
means for accessing network configuration information data from the network; and,
means for processing the selected mobile user information data, associated call history data and the access network configuration information data to develop mobile user position information data that represents geographical position of the mobile user in the network.

### BRIEF DESCRIPTION OF THE DRAWINGS

For a better understanding of the nature and objects of the present invention reference may be had to the accompanying diagrammatic drawings in which:

FIG. 1 is a schematic representation of the wireless telecommunication network of the present invention including the historical tracking analysis system;

FIG. 2 is a screen display showing the selection of historical data information;

FIG. 3 is another display showing the selection of data to be processed by the tracking system;

FIG. 4 is a first map showing the path of movement of a mobile user on a geographical map;

FIG. 5 is a geographical map showing the location of dropped calls identified by the tracking system;

FIG. 6 is a geographical map showing the usage and dropped calls in a given region of the network; and,

FIG. 7 is a schematic representation of a portion of the network and more detail of the client system.

### DETAILED DESCRIPTION OF THE INVENTION

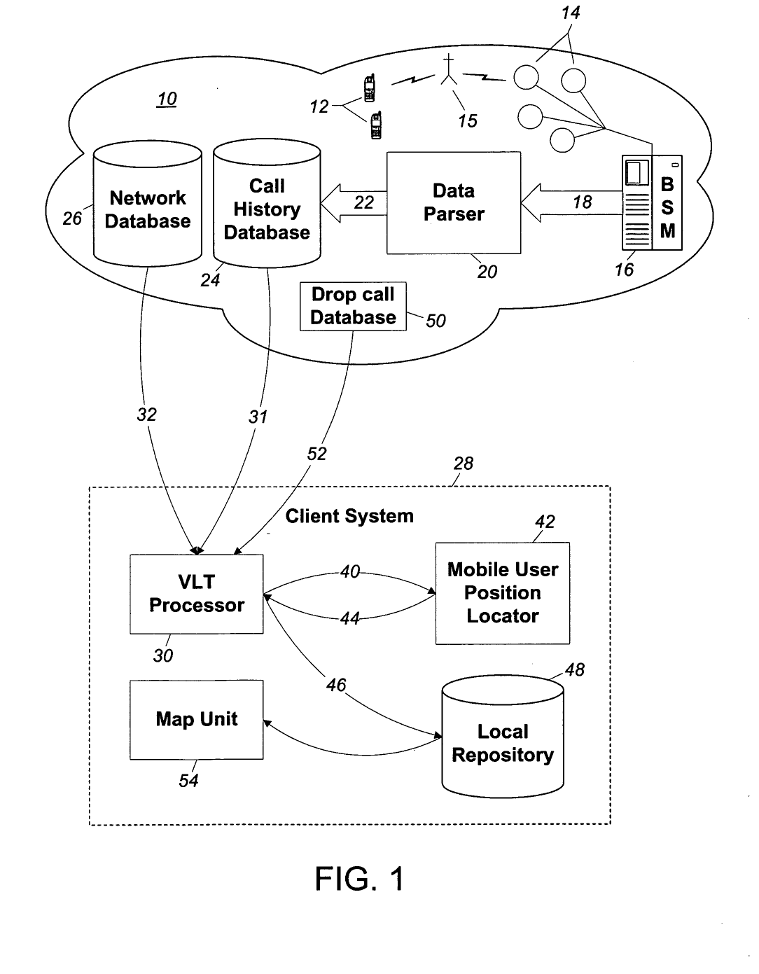

The present invention relates to a method and system for historical tracking of one or more mobile users while on a call in a wireless telecommunication network. In particular, FIG. 1 shows a telecommunication network as a wireless cellular mobile telephone network 10 having multiple mobile users 12 connected to the network 10 by radio wave to cell sites 14. Each cell site 14 is controlled by a base station manager (BSM) 16 for the network 10. The BSM 16 controls mobile user radio coverage in a predetermined region of the network 10. For the purpose of the description that follows, the cell site 14 and term base station cell site base station, or base station cell sites 14 may hereinafter be considered one and the same aspects of the network 10. It should be understood that a network 10 may have more than one BSM 16 and that each BSM 16 may control mobile user call connections in the network 10 through hundreds of cell sites 14. In addition the network 10 includes enhancers or repeaters 15 for improving signal levels from the cell site base station 14 to the mobile user 12. In some instances, radio signals between base station cell sites 14 may pass through an enhancer or repeater station 15 whereby the signal is amplified. The repeater 15 increases the cell site coverage area in network 10.

In accordance with the present invention, the base station manager (BSM) 16 in the network forwards raw data relating to telephone calls in progress by mobile users 12 in network 10 along communication link 18 to the data parsing unit 20. The data parsing unit (VLT parser) 20 acts as a vehicle locating tool parser and filters the raw data relating to calls on the network. The VLT parser 20 forwards filtered data along communication link 22 to a call history database 24. The call history database 24 is also referred to as a vehicle locating database. The raw data forwarded along communication link 18 from BSM 16 to the data parser 20 includes all information data relating to calls in progress of all users in the network. This raw data information is forwarded either on a real time basis or is downloaded from BSM16 to VLT parser 20 at set times throughout the day. In one embodiment downloading of new data from the BSM occurs when the network is not operating at peak conditions and would normally occur in the early hours of the morning. It should be further understood that data parser 20 may receive raw data from more than one BSM 16 in the network. Further, for very large networks more than one data parser 20 may service the network.

The data parser 20 then filters the raw data received that typically comprises rows of information relating to the mobile user information data and associated call history information data. The mobile user information includes the telephone number of the customer of the mobile user and the call history information includes the date and time of the call, call duration and information relating to the relative position of the mobile user in the network relative to the cell sites 14 and repeaters 15 through which the mobile user 12 is connected to network 10. The call history database stores the filtered call history information data and mobile user information data in a relational database.

The network further includes a network database 26. The purpose of the network database 26 is to provide in a spread sheet fashion data relating to the network configuration. This includes the longitudinal and latitude information concerning the location of each of the cell sites 14 and repeaters 15 in the network 10 and antenna azimuth. The network database 26 is accessible by network administrators who update cell site and repeater configurations. Database 26 is maintained and updated by the network administrator when new cell sites and repeaters are added and when any changes are made to the cell site, and repeater configurations by network administrators.

In accordance with the present invention, the tracking and analyzing system of the present invention is driven by a client system 28. The client system comprises a computer program tool that may be operating on a personal computer that has secure internet or intranet access to the call history database 24 and the network database 26 in the network 10. This access is represented by communication lines or links 31 and 32 respectively to the call history database 24 and the network database 26. It should be understood that client system 28 access to the network 10 is controlled by a log on procedure which normally requires that a user log on with an identification user name and a password.

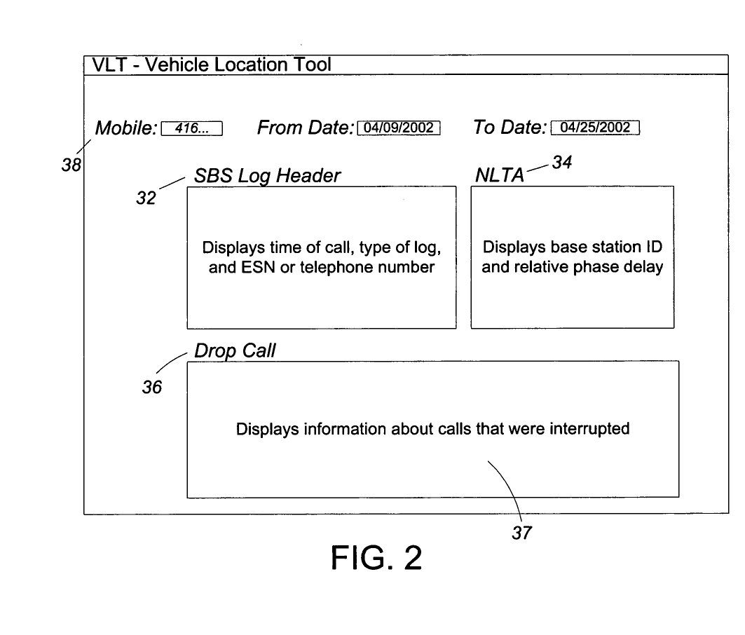

In tracking or analyzing the mobile user information data associated with active calls in the network and the associated call history information data, a VLT processor 30 acts as an interface for the administrator to access the network information. The VLT processor 30 is also referred to as a vehicle location tool processor. The VLT processor 30 utilizes the personal computer a display screen that brings up an interface display similar to that shown in FIG. 2. FIG. 2 shows three types of logs as SBS (System Base Station) logs at 32, NLTA (Neighbor List Tuning Array) logs at 34 and drop call logs at 36. The SBS logs are logs that occurred in the system and show the time, the type of log and the ESN or telephone number. The NLTA log relates more to the base station ID and relative phase delay of signals received from a mobile user from these base stations. The drop call log 36 relates to calls that were interrupted and lost due to network malfunctions such as, for example, poor signal strength or high traffic density.

In order to see these logs, the administrator provides to the VLT processor 30 with parameters such as start time (GMT standard), the end time (GMT standard) and the mobile phone number. All these parameters can be entered in the controls on the tool bar 38.

Once all the parameters are provided, the data is loaded into the table 37 shown in FIG. 2.

To view available mobile users, an administrator selects parameters such as, for example, a date range the base station controller which tracks the mobile, the mobile range and/or pattern. If no base station controller is selected, the conditions based on the base station controller are not used. Once the list of mobiles are provided, the administrator has the option, for example, to select mobiles from the listings for determination of path of travel or location of dropped calls. Once the selection is made, the VLT processor 30 downloads the selected information from the call history database 24 and downloads network configuration information associated with the selected calls from network database 26. The administrator then selects the calls for position location analysis and in so doing the VLT processor 30 forwards this call history data information and associated network database information via communication link 40 to the mobile user position locator 42.

It should be understood that over a given period of time, the logs provided by the BSM 16 to the call history database 24 may be numerous. Further, the number of calls to be processed may be quite numerous and as a result, due to current processing times of computers and memory constraints, the processing by the position location of the location information of each of the mobile users 12 so requested by the VLT processor 30 may require several hours until the processing is complete.

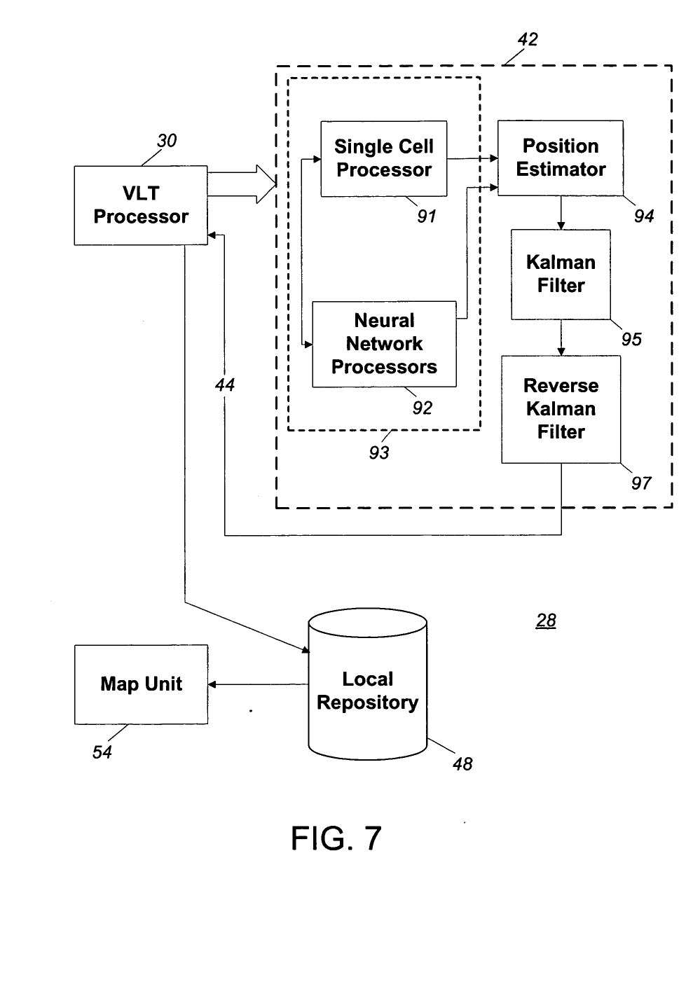

The mobile user position locator 42 analyzes each call record and computes the relative position of the mobile user 12 relative to one or more base station cell sites 14 or repeater station location 15. While there are many different manners in which to compute the relative location of a mobile user 12, the mobile user position locator 42 operates as shown in FIG. 7. In FIG. 7, the VLT processor 30 forwards selected call history information to an enhancer decision network 93 and network information received from network database 26. Decision network 93 forms part of the mobile user position locator 42. The purpose of enhancer decision network 93 is to determine if the call history data information relates to a signal propagating through an enhancer or repeater station 15.

The decision network 93 has a single cell processor 91 and neural network processors 92. For call history information received from a single cell 14, the record if forwarded by VLT processor 30 to single cell processor 91. For multiple cell records associated with the same call, that is a record associated with multiple base stations because the mobile user 12 is in a soft handoff situation, the records are forwarded to neural network 92

A single cell site record entering the single cell processor 91 has its location determined by RTD information. The RTD information comprises round trip delay information of the signal as it propagates from the base station to the mobile and returns back to the base station 14. In some instances, this propagation may be through a repeater station 15 and hence has greater delay. The purpose of the single cell processor 91 is to determine whether or not the propagation delay of the RTD record for the mobile user is associated with a repeater station 15. The single cell processor 91 has a predetermined delay time associated with a signal passing from the cell site to the repeater and through the repeater to the mobile station. If the RTD measurement is greater than this value, it cannot be ascertained whether or not the signal is passing through a repeater station or is in fact a significant distance away from the cell site. The single cell processor in this instance discards this value and will not provide this value to the position estimator 91. When the value is less than this normal delay propagation, a position will be calculated for the user. For a single cell reference, the position estimate processor uses a triangulation method whereby the time delay is representative of a distance from the repeater station or the base station and the azimuth of the repeater station or base station together with the time delay give the coordinate of the mobile user relative to the base or repeater station.

In the event of multiple call records, it should be understood that these multiple call records may either have an RTD component or the Neighbor List Tuning Array (NLTA) information. This NLTA information is also referred to as PSMM messages which stands for Power Strength Measurement Messages which are related to phase delays between the cell sites involved in a soft hand off situation for the signal received by the mobile user. The neural network processor 92 has trained neural networks for both RTD measurements and PSMM measurements. When the actual measurement is received by the neural network processor 92, the measurement is placed within the trained neural network and the proximity of this measurement to known calculations result in the neural network determining whether a cell enhancer or repeater is involved in the propagation of the signal to the mobile user 12. If it is, a revised repeater position information sent to the position estimating processor 42. If the neural network determines that the call has not passed through a repeater station 15, then the call history information is forwarded without revision to the position estimator 94. Hence the position estimator 94 perform the same tasks on call history data information and revised call history data information altered by the neural network processors 92. Alternatively, revision to call history data information could occur in the position estimator 94 prior to processing. In the instance where two cell sites are in soft handoff, there is a calculation using the RTDs information from both cell sites by means of circular trilateration. For RTDs call history data information for more than three cells, circular trilateration is utilized by the position estimator 94 to estimate the position of the mobile user 12. For the instance where PSMM messages are used, a hyperbolic trilateration is used to locate the mobile user.

The output of the position estimator 94 is a rough or raw position estimation of the location of mobile user 14 in the network 10. This information is refined by a Kalman filter 95 which compares the new position estimate information with previous stored position estimates of information for the mobile user 14. As a result, the Kalman filter helps or alter the position estimate for the mobile user within the network.

Once the last record in a call log history has been processed by position estimator 94 and passed through the Kalman filter 95, then a reverse Kalman filter 97 re-evaluates all position estimates for that call in a reverse direction and revises the position estimates of the mobile user 14 within a repository database 97.

The position estimate information is then transmitted back via communication link 44 to the VLT processor 30. The VLT processor 30 then develops a mobile user position information data that represents a geographical position of the mobile user in the network. The VLT processor 30 in combination with the mobile user position locator 42 determines the longitudinal and latitudinal co-ordinates of a selected mobile. The VLT processor 30 and the mobile user position locator 42 collectively act as a mobile user positioning processor that is responsive to the selected mobile user information data, associated call history data and the access configuration information data to develop mobile user position information data that represents the geographical position of the mobile user in the network. While in the one embodiment the VLT processor 30 receives mobile user position information from the mobile user position locator 42 and processes this information with the network database information 26, it should be understood that it may be possible for this entire processing function to occur in the mobile user position locator 42.

In any event, the mobile user position information data is next forwarded from VLT processor 30 via linked communication line 46 to the local repository database 48. The purpose of the local repository database 48 is to store all information that has been calculated by the processors 30 and 42 locally in the client system 28 so as to save storage space in the call history database 24 and to improve performance.

In accordance with the one aspect of the present invention, any mobile user position information data that relates to a dropped call is also forwarded back to a drop call database 50 located in the network 10. This dropped call information is either forwarded directly from the VLT processor 34 along link line 52 or alternatively may be forwarded by the local repository 48 to the drop call database 50. Due to the importance of the information related to drop calls to the efficiency of the operation of the network 10, the present invention stores the information in a call database 50 within the network. This allows other administrators to access and review this drop call information from the network 10 without having to go calculate position estimates for the mobile user position 14.

It should also be understood that the VLT processor 30 prior to computing any selected information from the call history database 24 to determine the mobile user position information data may also check along link line 46 to the local repository 48 and also the drop call database 50 along link line 52 to determine if the actual position information has already been developed. If so, this prevents any redundant processing by the client system 28.

The VLT processor 30 may also be accessed by the administrator of the client system 28 to view the data relating to the mobile user position information data of selected calls from the local repository. The VLT processor instructs the local repository to send selected call information to a mapping unit or map unit 54. The map unit displays selected criteria from the local repository 48 in many different configurations.

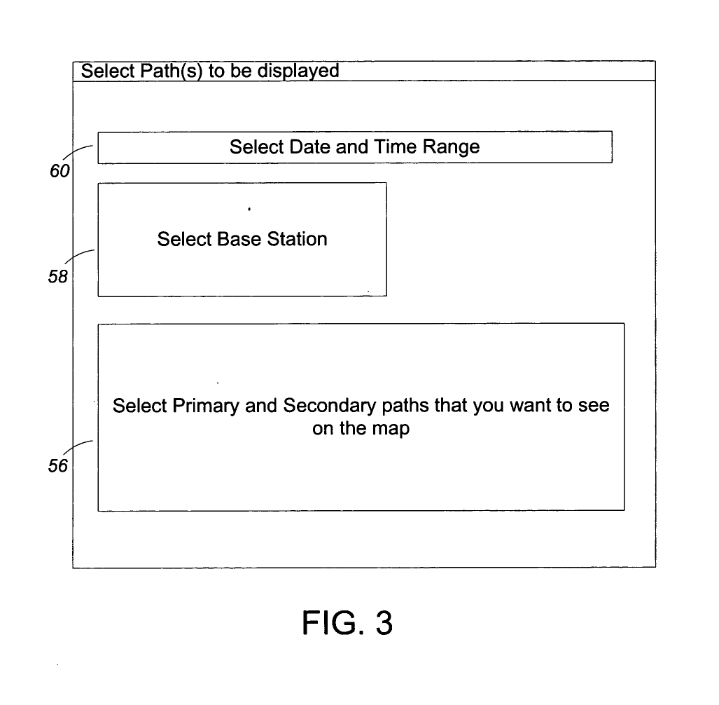

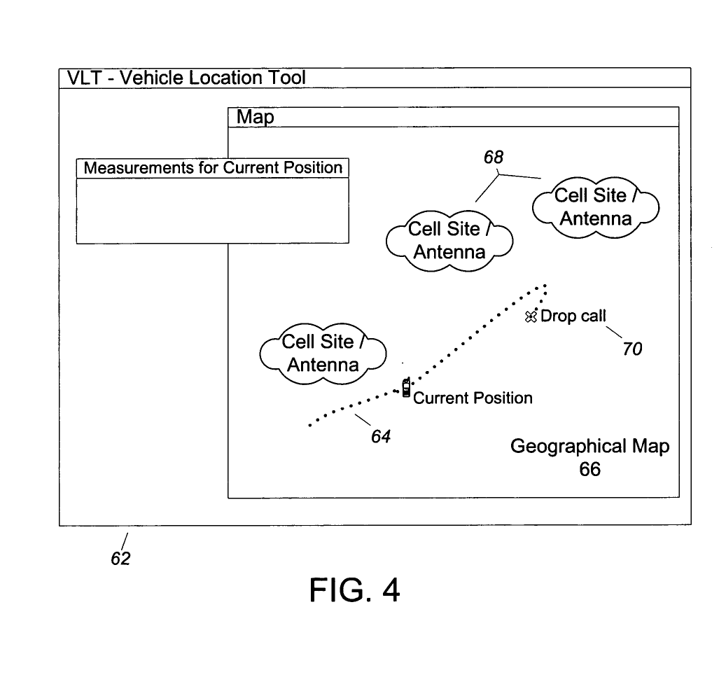

In one configuration, once a mobile path or the path of a mobile user within the network is calculated successfully it can become available for replay. The mobile path replay is selected by the administrator by setting the date and time range to obtain a list of only those calls which started within a specific time range and are stored in the local repository 48. Further, if a base station manager 16 is specified, then only those calls which took place in the area of the base station manager 16 are shown. The user may have an option to select multiple base station cell sites. Further, the VLT processor 30 then provides a screen or a replay screen similar to that shown in FIG. 3. In the replay screen of FIG. 3, there is a selection for primary and secondary mobiles to be reviewed at rows 56. The administrator selects a specific telephone number and then designates that telephone number as a primary number. The administrator also selects other numbers as secondary numbers. Further in the base station manager column 58, the user may select the base station manager for calls and also the date range and time range may be selected along row 60. Once this information is selected, a map showing the pathway is generated as shown in FIG. 4.

The replay screen 62 of FIG. 4 shows the travelling path 64 of a mobile user on a geographical map 66. The path of travel 64 is shown relative to cell sites or antennas 68. Further, the location 70 is shown where the call was dropped. This is a very useful tool in tracking the path of travel of a mobile user in the system and allows system administrators to reconfigure the network to improve network performance. All of the points shown in the path of travel are labeled 64.

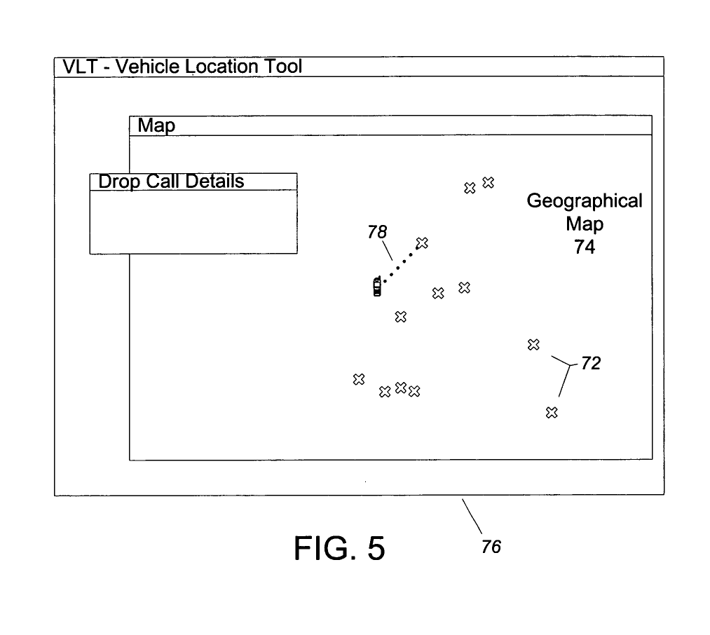

Another analysis that may be provided by the VLT processor 30 through the local repository 48 and the map unit 54 is that of analyzing dropped calls in the network. The dropped calls can be displayed by specific criteria on the map. There are two possible sources of located dropped calls. The first is the local repository 48 on the client system 28. The other source is the drop call database 50 located in the network 10. The user can set a date and time range and select a base station manager 16 area where the dropped call has occurred. If no base station is selected the condition is not applied. The dropped calls are then reviewed by region and time and date from the database and an analysis or screen similar to that shown in FIG. 5 is mapped to show the location of dropped calls 72 on the geographical map 74. This is a very useful tool as it provides to the administrator a visual representation of where dropped calls have occurred. In the screen 76 of FIG. 5 the tracking of one of dropped the calls is shown at 78.

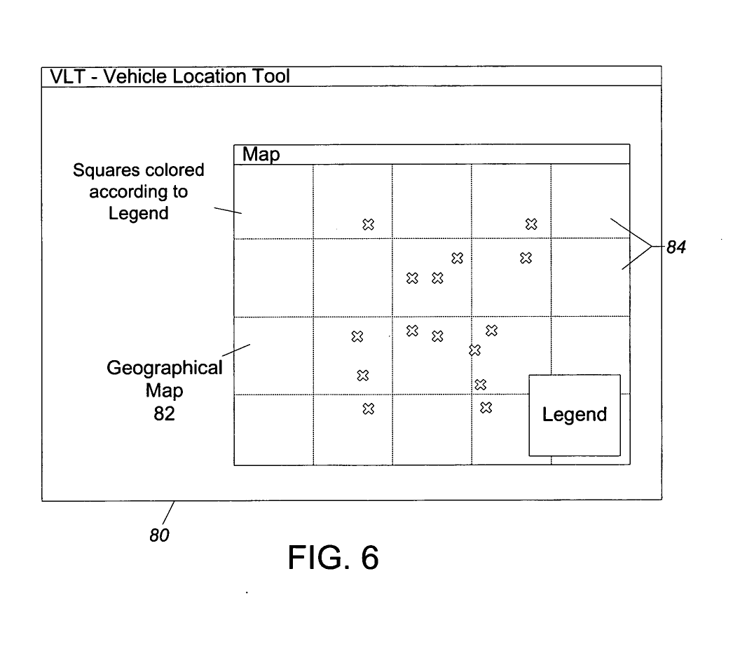

Another function of the VLT processor 30, the local repository 48 and the mapping unit 54 is to provide a network utilization layer as shown in the screen of FIG. 6. The screen 80 shows a geographical map 82 with the map broken into square regions 84. Each of the regions 86 in one embodiment is colour coded and is shown in the representation of FIG. 6 herein as different shades of gray. Each of the colour codings represents the number of calls occurring in a given time period in that sector. This layering of information provided in the sector grids relates to the density of mobile user calls in a predetermined region of the network. This allows the administrators to see the network utilization of each of the sectors in the network during different periods of time.

The functionality of the present invention may comprise one or more components ports embodied in software, hardware or a combination thereof.

It should be understood that other embodiments of the present invention may be readily apparent to a person skilled in the art in view of the above detailed description of the invention. Accordingly, the scope of the present invention should not be limited to the teachings above and should be limited to the scope of the claims that follow.

1. A wireless communication network having a mobile user tracking system for collecting data associated with mobile users making calls in the network, the tracking system comprising:
a data parsing unit for receiving data associated with calls made by mobile users in the network and for filtering the data into parsed data that includes mobile user information data and associated call history information data;
a call history database for storing the parsed data; and
a client system adapted to access selected mobile user information data and associated call history information data from the call history database and to access network configuration information data from a network configuration database, and the client system having a mobile user positioning system responsive to the selected mobile user information data, associated call history data and the access network configuration information data to develop mobile user position information data that represents geographical position of the mobile user in the network.

2. The wireless communication network of claim 1, wherein the data parsing unit receives data associated with calls made by mobile users in the network at predetermined times.

3. The wireless communication network of claim 2, wherein the predetermined times are when the network is not operating at peak conditions.

4. The wireless communication network of claim 1, wherein the data parsing unit receives data associated with calls made by mobile users in the network from at least one base station manager.

5. The wireless communication network of claim 1, wherein the data parsing unit receives data associated with calls made by mobile users in the network from a plurality of base station managers.

6. The wireless communication network of claim 1, wherein the client system further includes a local storage database for storing the mobile user position information data.

7. The wireless communication network of claim 1, wherein the client system further includes a mapping display unit that displays the developed mobile user position information data on a geographical map of at least a portion of the network.

8. The wireless communication network of claim 7, wherein the client system further includes a local storage database for storing the mobile user position information data and wherein the mapping display unit receives the developed mobile user position information data from the local storage database.

9. The wireless communication network of claim 7, wherein the mapping display unit displays a tracked mobile user call in progress as the mobile user moves through the network.

10. The wireless communication network of claim 7, wherein the mapping display unit displays a density of mobile user calls in a predetermined region of the network.

11. The wireless communication network of claim 7, wherein the mapping display unit displays one or more dropped calls in a predetermined region of the network.

12. The wireless communication network of claim 1 further comprising a remote network drop call database that stores drop call position information that is accessible to other client systems.

13. The wireless communication network of claim 1, wherein the mobile user positioning system comprises an administrative unit and a processing unit, the administrative unit receiving the selected mobile user information data, associated call history information data and network configuration information data and forwarding the selected mobile user information data, associated call history information data and network configuration information data to the processing unit for development of the mobile user position information data.

14. The wireless communication network of claim 1, wherein the mobile user positioning system comprises an administrative unit and a processing unit, the administrative unit receiving the selected mobile user information data, associated call history information data and network configuration information data and forwarding the selected mobile user information data and associated call history information data to the processing unit for development of initial mobile user position information data, and the processing unit forwarding the initial mobile user position information back the administrative unit that processes the initial mobile user position information with the network configuration information data to develop the mobile user position information data.

15. The wireless communication network of claim 1, wherein the mobile user information data comprises customer information data including customer telephone numbers.

16. The wireless communication network of claim 1, wherein the associated call history information data for a call comprises at least one of a time of the call, a duration of the call and information relating to the relative position of the mobile user in the network relative to at least one of a cell site and a repeater through which the mobile user is connected to the network.

17. The wireless communication network of claim 1, wherein the associated call history information data for a call comprises information relating to the relative position of the mobile user in the network relative to at least one of a cell site and a repeater station through which the mobile user is connected to the network.

18. The wireless communication network of claim 17, wherein the mobile user positioning system is operable to determine if the call history data information relates to a call propagating through a repeater station and to develop the mobile user position information data based upon the information relating to the relative position of the mobile user and the determination of whether the call history data information relates to a call propagating through a repeater station.

19. The wireless communication network of claim 1, wherein the selected mobile user information data and associated call history data is selected by one or more of network region, telephone number, and time of day.

20. The wireless communication network of claim 1 wherein the associated call history information data includes dropped call information.

21. The wireless communications network of claim 1, wherein the network comprises a cellular telecommunication system having at least one switching base station and a plurality of cells.

22. A tracking system for use in a wireless communication network for analyzing data associated with a mobile user on calls in the network, the mobile user tracking system comprising:
a client system adapted to access mobile user information data and associated call history information data from the network and adapted to access network configuration information data from the network, and the client system having a mobile user positioning system responsive to the accessed mobile user information data, associated call history data and the access network configuration information data to develop mobile user position information data that represents geographical position of the mobile user in the network.

23. The tracking system of claim 22, wherein the accessed mobile user information data and associated call history information data corresponds to data received from the network at predetermined times.

24. The tracking system of claim 23, wherein the predetermined times are when the network is not operating at peak conditions.

25. The tracking system of claim 22, wherein the client system further includes a local storage database for storing the mobile user position information data.

26. The tracking system of claim 22, wherein the client system further includes a mapping display unit that displays the developed mobile user position information data on a geographical map of at least a portion of the network.

27. The tracking system of claim 26, wherein the client system further includes a local storage database for storing the mobile user position information data and wherein the mapping display unit receives the developed mobile user position information data from the local storage database.

28. The tracking system of claim 26, wherein the mapping display unit displays a tracked mobile user call in progress as the mobile user moves through the network.

29. The tracking system of claim 26, wherein the mapping display unit displays a density of mobile user calls in a predetermined region of the network.

30. The tracking system of claim 26, wherein the mapping display unit displays one or more dropped calls in a predetermined region of the network.

31. The tracking system of claim 22 further comprising a remote network drop call database that stores drop call position information that is accessible to other client systems.

32. The tracking system of claim 22, wherein the mobile user positioning system comprises an administrative unit and a processing unit, the administrative unit receiving the selected mobile user information data, associated call history information data and network configuration information data and forwarding the selected mobile user information data, associated call history information data and network configuration information data to the processing unit for development of the mobile user position information data.

33. The tracking system of claim 22, wherein the mobile user positioning system comprises an administrative unit and a processing unit, the administrative unit receiving the selected mobile user information data, associated call history information data and network configuration information data and forwarding the selected mobile user information data and associated call history information data to the processing unit for development of initial mobile user position information data, and the processing unit forwarding the initial mobile user position information back the administrative unit that processes the initial mobile user position information with the network configuration information data to develop the mobile user position information data.

34. The tracking system of claim 22, wherein the associated call history information data for a call comprises at least one of a time of the call, a duration of the call and information relating to the relative position of the mobile user in the network relative to at least one of a cell site and a repeater through which the mobile user is connected to the network.

35. The tracking system of claim 22, wherein the associated call history information data for a call comprises information relating to the relative position of the mobile user in the network relative to at least one of a cell site and a repeater station through which the mobile user is connected to the network.

36. The tracking system of claim 35, wherein the mobile user positioning system is operable to determine if the call history data information relates to a call propagating through a repeater station and to develop the mobile user position information data based upon the information relating to the relative position of the mobile user and the determination of whether the call history data information relates to a call propagating through a repeater station.

37. The tracking system of claim 22, wherein the accessed mobile user information data and associated call history is selected by one or more of network region, telephone number, and time of day.

38. The tracking system of claim 22, wherein the associated call history information data includes dropped call information.

39. The tracking system of claim 22, wherein the network comprises a cellular telecommunication system having at least one switching base station and a plurality of cells.

40. A method of tracking mobile users in a wireless communication network comprising:
collecting data associated with mobile users making calls in the network;
filtering the collected data into parsed data that includes mobile user information data and associated call history information data;
storing the parsed data in the network; and
developing mobile user position information data that represents geographical position of the mobile user in the network from the mobile user information data, the associated call history data and access network configuration information data.

41. The method of tracking mobile users of claim 40, wherein the collecting data associated with mobile users making calls in the network occurs at predetermined times.

42. The method of tracking mobile users of claim 41, wherein the predetermined times are when the network is not operating at peak conditions.

43. The method of tracking mobile users of claim 40 further comprising displaying the developed mobile user position information data on a geographical map of at least a portion of the network.

44. The method of tracking mobile users of claim 43, wherein the displaying the developed mobile user position information data comprises displaying a tracked mobile user call in progress as the mobile user moves through the network.

45. The method of tracking mobile users of claim 43, wherein the displaying the developed mobile user position information data comprises displaying a density of mobile user calls in a predetermined region of the network.

46. The method of tracking mobile users of claim 43, wherein the displaying the developed mobile user position information data comprises displaying one or more dropped calls in a predetermined region of the network.

47. The method of tracking mobile users of claim 40, wherein the associated call history information data for a call comprises information relating to the relative position of the mobile user in the network relative to at least one of a cell site and a repeater station through which the mobile user is connected to the network.

48. The method of tracking mobile users of claim 47, wherein the developing mobile position user information data comprises determining if the call history data information relates to a call propagating through a repeater station and developing the mobile user position information data based upon the information relating to the relative position of the mobile user and the determination of whether the call history data information relates to a call propagating through a repeater station.

49. A method of remotely analyzing data associated with mobile users on calls in the wireless communication network, the method comprising:
accessing selected mobile user information data and associated call history information data from the network;
accessing network configuration information data from the network; and
processing the selected mobile user information data and associated call history data and the access network configuration information data to develop mobile user position information data that represents geographical position of the mobile user in the network.

50. The method of remotely analyzing data of claim 49, wherein the selected mobile user information data and associated call history information data corresponds to data received from the network at predetermined times.

51. The method of remotely analyzing data of claim 50, wherein the predetermined times are when the network is not operating at peak conditions.

52. The method of remotely analyzing data of claim 49 further comprising storing the mobile user position information data in a local repository database.

53. The method of remotely analyzing data of claim 49 further comprising displaying the developed mobile user position information data on a geographical map of at least a portion of the network.

54. The method of remotely analyzing data of claim 53, wherein the displaying the developed mobile user position information data comprises displaying a tracked mobile user call in progress as the mobile user moves through the network.

55. The method of remotely analyzing data of claim 53, wherein the displaying the developed mobile user position information data comprises displaying a density of mobile user calls in a predetermined region of the network.

56. The method of remotely analyzing data of claim 53, wherein the displaying the developed mobile user position information data comprises displaying one or more dropped calls in a predetermined region of the network.

57. The method of remotely analyzing data of claim 49, wherein the selected mobile user information data and associated call history is selected by one or more of network region, telephone number, and time of day.

58. The method of remotely analyzing data of claim 49, wherein the associated call history information data for a call comprises information relating to the relative position of the mobile user in the network relative to at least one of a cell site and a repeater station through which the mobile user is connected to the network.

59. The method of remotely analyzing data of claim 58, wherein the processing the selected mobile position user information data and associated call history data and the access network configuration information data comprises determining if the call history data information relates to a call propagating through a repeater station and developing the mobile user position information data based upon the information relating to the relative position of the mobile user and the determination of whether the call history data information relates to a call propagating through a repeater station.

60. An apparatus for tracking mobile users in a wireless communication network comprising:
means for collecting data associated with mobile users making calls in the network,
means for filtering the collected data into parsed data that includes mobile user information data and associated call history information data;
means for storing the parsed data in the network; and
means for developing mobile user position information data that represents geographical position of the mobile user in the network from the selected mobile user information data, associated call history data and the access network configuration information data.

61. The apparatus of claim 60, wherein the means for collecting data associated with mobile users making calls in the network comprises means for collecting data associated with mobile users making calls in the network at predetermined times.

62. The apparatus of claim 61, wherein the predetermined times are when the network is not operating at peak conditions.

63. The apparatus of claim 60 further comprising means for displaying the developed mobile user position information data on a geographical map of at least a portion of the network.

64. The apparatus of claim 63, wherein the means for displaying comprises means for displaying at least one of a tracked mobile user call in progress as the mobile user moves through the network, a density of mobile user calls in a predetermined region of the network, and a display of one or more dropped calls in a predetermined region of the network.

65. The apparatus of claim 60, wherein the associated call history information data for a call comprises information relating to the relative position of the mobile user in the network relative to at least one of a cell site and a repeater station through which the mobile user is connected to the network; and
wherein the means for developing mobile position user information data comprises means for determining if the call history data information relates to a call propagating through a repeater station and means for developing the mobile user position information data based upon the information relating to the relative position of the mobile user and the determination of whether the call history data information relates to a call propagating through a repeater station.

66. An apparatus for remotely analyzing data associated with mobile users on calls in the wireless communication network, the apparatus comprising:
means for accessing selected mobile user information data and associated call history information data from the network;
means for accessing network configuration information data from the network; and
means for processing the selected mobile user information data, associated call history data and the access network configuration information data to develop mobile user position information data that represents geographical position of the mobile user in the network.

67. The apparatus of claim 66, wherein the selected mobile user information data and associated call history information data corresponds to data received from the network at predetermined times.

68. The apparatus of claim 67, wherein the predetermined times are when the network is not operating at peak conditions.

69. The apparatus of claim 66 further comprising means for displaying the developed mobile user position information data on a geographical map of at least a portion of the network.

70. The apparatus of claim 69, wherein the means for displaying comprises means for displaying on the map at least one of a tracked mobile user call in progress as the mobile user moves through the network, a density of mobile user calls in a predetermined region of the network, and a display of one or more dropped calls in a predetermined region of the network.

71. The apparatus of claim 66, wherein the associated call history information data for a call comprises information relating to the relative position of the mobile user in the network relative to at least one of a cell site and a repeater station through which the mobile user is connected to the network; and
wherein the means for processing the selected mobile user information data, associated call history data and the access network configuration information data comprises means for determining if the call history data information relates to a call propagating through a repeater station and means for developing the mobile user position information data based upon the information relating to the relative position of the mobile user and the determination of whether the call history data information relates to a call propagating through a repeater station.
